(19) United States
(12) Patent Application Publication
(10) Pub. No.: US 2021/0082091 A1
(43) Pub. Date: Mar. 18, 2021

(54) DIGITAL IMAGE EDITING

(71) Applicant: Indie Works Corp., Tustin, CA (US)

(72) Inventor: Payam Jirsa, Tustin, CA (US)

(21) Appl. No.: 17/020,695

(22) Filed: Sep. 14, 2020

Related U.S. Application Data
(60) Provisional application No. 62/900,014, filed on Sep. 13, 2019.

(51) Int. Cl. G06T 5/00

(52) U.S. Cl. CPC G06T 5/007; G06T 2200/24; G06T 2207/20208; G06T 2207/20092

(57) ABSTRACT

A coordinated preset group comprises a plurality of condition presets that work with image editing software to apply a specialized group of editing settings to a native digital image upon actuation of the preset. Applying the editing settings transform the native image into an image having a desired look. Each condition preset of the coordinated preset group is configured to achieve the desired look when starting with a native image having a condition (such as a lighting condition) targeted by that particular condition preset.

### CROSS-REFERENCE TO RELATED APPLICATIONS

This application claims the benefit of U.S. Provisional Application Ser. No. 62/900,014, which was filed on Sep. 13, 2019, the entirety of which is hereby incorporated by reference.

### BACKGROUND

The present disclosure relates to the field of digital image editing.

In the art of photography, capturing an image with a camera is only part of the process. Digital image editing software packages enable a user to edit native still and video images in a multitude of ways in order to create a final image that achieves a desired visual effect. The desired visual effect is, of course, based on the captured image, but the manner in which the colors are displayed has been enhanced so as to provide a visual image having a desired aesthetic style, or “look”.

Image editor software options have various tools available to enable a user starting with a native image to manipulate color presentation so as to create an end-result image having a different look than the original, native digital image. Typically, such image editing software enables users to manipulate color presentation by making adjustments to certain editing settings so as to, for example, increase or decrease the brightness of pixels having certain attributes such as brightness, color, or the like. Typically there are several different editing settings that can be adjusted.

Some image editing software packages provide and/or accommodate downloads of “presets” tied to particular looks. These presets include, in memory, a set of editing settings corresponding to a particular look. Thus, when the user selects a particular preset, the software will apply the associated editing settings to the image in order to achieve (or at least estimate) the associated desired look. Thus, application of a preset can help a user achieve a desired look quickly, without having to go through the laborious task of adjusting a multitude of editing settings. Presets thus can lead to great time savings for users.

Presets, however, have limitations because of the broad range of variables associated with photographic images. For example, a preset that results in a visually stunning and beautiful image of a mountain landscape may, if applied to a close-up portrait shot with a flash, result in an unnatural-looking and undesirable image. Conditions in the original, or native, image, such as lighting conditions, the scene, composition and the dynamic range within the image, vary from image to image. Thus, applying the same preset to two different images will not necessarily yield the same look. As such, the time-saving utility of presets is limited due to variations of conditions in the native digital image.

### SUMMARY

The present specification provides embodiments in which a group of presets corresponds to a particular look, but each preset within the group is configured to achieve the desired look beginning with a native image having a particular underlying condition. The present specification also provides a method for creating such coordinated preset groups. Further, the present specification provides a method of using artificial intelligence (AI) both in creating presets and in applying presets to native images so as to achieve a desired look.

In accordance with one embodiment, the present description provides a method for editing a group of native images using an image processing software. The method includes selecting a coordinated preset group corresponding to a desired look to be shared by the group of native images after editing. The coordinated preset group comprises a first preset and a second preset, the first preset comprising a first group of image editing settings that, when applied to a native image having a first condition, modify the native image to approximate the desired look. The second preset comprises a second group of image editing setting that, when applied to a native image having a second condition, modify the native image to approximate the desired look. It is determined that a first native image of the group of native images has the first condition, and the first preset is applied to the first native image to transform the first native image to a first transformed image. It is determined that a second native image of the group of native images has the second condition, and the second preset is applied to the second native image to transform the second native image to a second transformed image.

In one such embodiment, the first and second transformed images both approximate the desired look.

Another embodiment additionally comprises determining whether a third image of the group of images has the first condition or the second condition, and applying the first preset to the third image if the third image has the first condition, and applying the second preset to the third image if the third image has the second condition.

In another embodiment, the first condition is a first lighting condition and the second condition is a second lighting condition.

Yet another embodiment additionally comprises applying a third preset to the first transformed image. In some such embodiments, the third preset is configured to transform the first transformed image from color to black and white while maintaining the desired look.

In still another embodiment, the image editing software enables adjustment of a first plurality of editing settings, and wherein the first and second presets adjust a second plurality of editing settings that is a subset of the first plurality of editing settings.

In a yet further embodiment, applying the first preset to the first native image comprises adjusting editing settings associated with the first native image to match the first group of editing settings. Some such embodiments can additionally comprise defining a first localized feature of the first image, and wherein applying the first preset to the first images comprises excluding adjustments of editing settings within the first localized feature.

A still further embodiment comprises an artificial intelligence analyzing the first native image and determining that the first native image has the first condition.

In a preferred embodiment, the first condition comprises a first plurality of lighting scenarios. Images exhibiting any of the first plurality of lighting scenarios can be expected to achieve a similar aesthetic result when edited in a similar manner.

In accordance with another embodiment, the present specification provides a method of creating a coordinated image editing preset group for use with image editing software. The method comprises determining a desired look, and identifying first through nth first native images having a first condition. For each of the first through nth first native images editing settings are modified to create a respective first transformed image having the desired look and having a plurality of respective first editing settings. The plurality of respective first editing settings of the respective first transformed image are documented. A first middle profile is calculated, and comprises a statistical calculation considering the plurality of respective first editing settings of each of the first through nth first transformed images, the first middle profile comprising a plurality of first middle editing settings. The plurality of first middle editing settings are saved as a first condition preset of the coordinated preset group. First through nth second native images having a second condition are identified. For each of the first through nth second native images editing settings of the respective second native image are modified to create a respective second transformed image having the desired look and having a plurality of respective second editing settings. The plurality of respective second editing settings of the respective second transformed image are documented, and a second middle profile is calculated comprising a statistical calculation considering the plurality of respective second editing settings of each of the first through nth second transformed images, the second middle profile comprising a plurality of second middle editing settings. The plurality of second middle editing settings are saved as a second condition preset of the coordinated preset group.

In some embodiments the first condition is a first lighting condition and the second condition is a second lighting condition.

Another embodiment additionally comprises modifying editing settings of a plurality of color images having the desired look to transform each of the plurality of color images into a black & white image having the desired look, saving the modified editing settings of each black & white image, calculating a black & white middle profile comprising a statistical calculation considering the modified editing settings, the black & white middle profile comprising a plurality of black & white middle editing settings, and saving the plurality of black & white middle editing settings as a black & white preset of the coordinated preset group.

In yet another embodiment the statistical calculation comprises calculating an average or identifying a median.

A further embodiment additionally comprises identifying a creation native image having the first condition, modifying editing settings for the creation native image to transform it to a creation transformed image having the desired look, saving a plurality of the initial editing settings of the creation transformed image as a development profile, and for each of the first through nth first native images, applying the saved initial editing settings to the respective first native image.

In accordance with yet another embodiment, the present specification provides a coordinated preset group configured for use with an image editing software. A first condition preset comprises a first group of editing settings, and is configured so that when the first condition preset is selected by the image editing software, the first group of editing settings replace a corresponding existing group of editing settings of a native digital image. A second condition preset comprises a second group of editing settings, and is configured so that when the second condition preset is selected by the image editing software, the second group of editing settings replace a corresponding existing group of editing settings of the native digital image. The first group of editing settings is configured so that when it replaces a corresponding existing group of editing settings of a first native image having a first condition, the first native digital image is transformed to a first transformed image having a desired look. The second group of editing settings is configured so that when it replaces a corresponding existing group of editing settings of a second native digital image having a second condition that differs from the first condition. the second native digital image is transformed to a second transformed image having the desired look.

In another embodiment the first and second conditions consider one or more of a dynamic range, lighting condition, scene, and compo siting of the native image.

In yet another embodiment, the first and second conditions are different from one another and comprise one of a soft light condition, a hard light condition, a high dynamic range condition, a backlit condition, a tungsten condition, a tungsten mix condition, a green tint condition, a red tint condition, and an over saturated condition.

In a further embodiment, the first condition comprises a first plurality of lighting scenarios, and images exhibiting any of the first plurality of lighting scenarios can be expected to achieve a similar aesthetic result when edited in a similar manner.

In accordance with still another embodiment, the present specification provides a method of editing digital images. The method includes evaluating a lighting scenario exhibited by a digital image and determining that the lighting scenario fits within a first group of a plurality of groups of lighting scenarios. Each group includes a plurality of lighting scenarios. For lighting scenarios within a particular group, digital images edited in a similar manner can expect to achieve a similar aesthetic look.

Another embodiment comprises grouping lighting scenarios in consideration of how images exhibiting such lighting scenarios respond to similar manners of editing so that images that respond similarly to similarly manners of editing are in the same group.

### BRIEF DESCRIPTION OF THE DRAWINGS

FIG. 1 depicts a tone curve of an image editing software;

FIG. 2 depicts example image editing settings of an image editing software;

FIG. 3 depicts further example image editing settings of an image editing software;

FIG. 4 depicts a display of an image editing software depicting a menu for accessing presets;

FIG. 5 depicts a close-up view of a menu displaying embodiments of coordinated preset groups;

FIG. 6 is a flow chart demonstrating an embodiment of using preset groups to achieve a desired look;

FIG. 7 is a flow chart depicting an embodiment of creating a coordinated preset group;

FIG. 8 depicts additional example editing settings of an image editing software;

FIG. 9 is a screenshot employed in developing a preset group in accordance with an embodiment; and

FIG. 10 is a flowchart depicting another embodiment using coordinated preset groups to achieve a desired look.

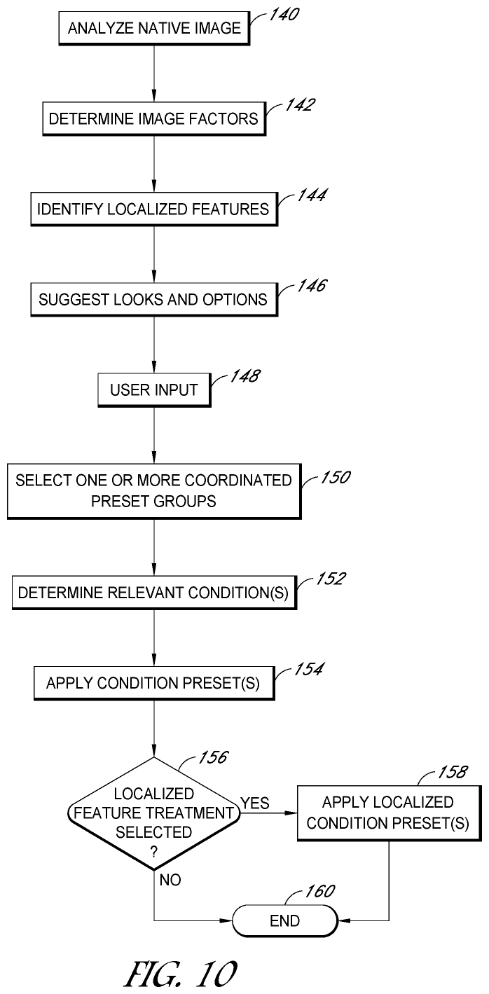

### DESCRIPTION

The present specification describes inventive features in the context of multiple embodiments. It is to be understood that the embodiments described below are presented as examples, and that the inventive features can be employed in other contexts and in association with additional, or fewer, other features.

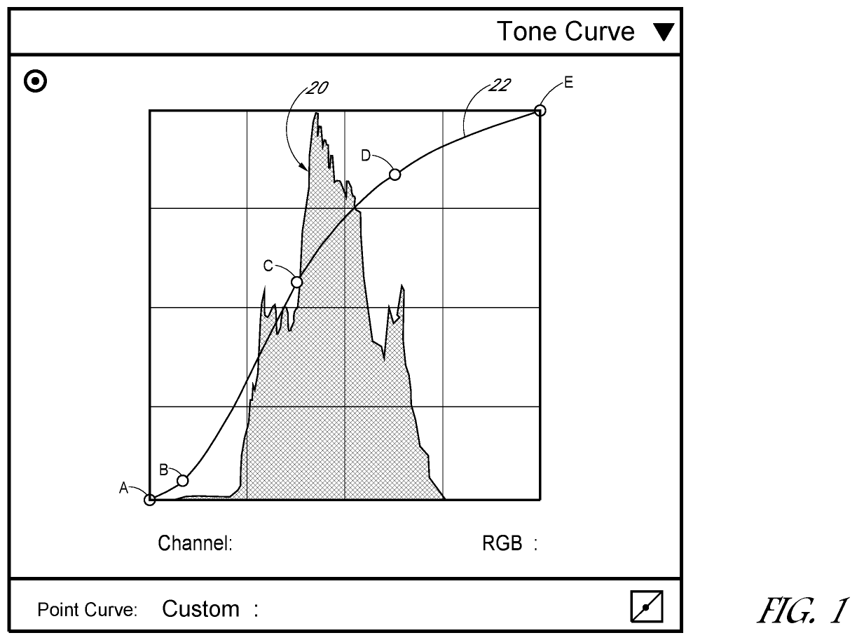

With initial reference to FIG. 1, many image editors create an image histogram 20 (also sometimes called a “tone curve”) of the native image being edited. The histogram 20 plots the number of pixels in the image (vertical axis) having a particular brightness value (horizontal axis). Such histograms 20 may be created for the image in general and/or for each of several colors and/or for combined colors (i.e., RGB). A line 22, typically straight when in a default position, indicates a level of emphasis of the different classes of pixels. Algorithms in the digital editor allow the user to adjust editing settings, which will adjust the brightness values of some or every pixel and some image editors will dynamically display the results as adjustments are made. Picture brightness, contrast and color presentation can thus be manipulated in order to achieve a desired aesthetic, or “look”. For example, a user may define any number of points A-E on the line 22, and by manipulating one or more of the points alter the curve of the line 22 (i.e., the tone curve) to manipulate the brightness/emphasis of certain classes of pixels in the image.

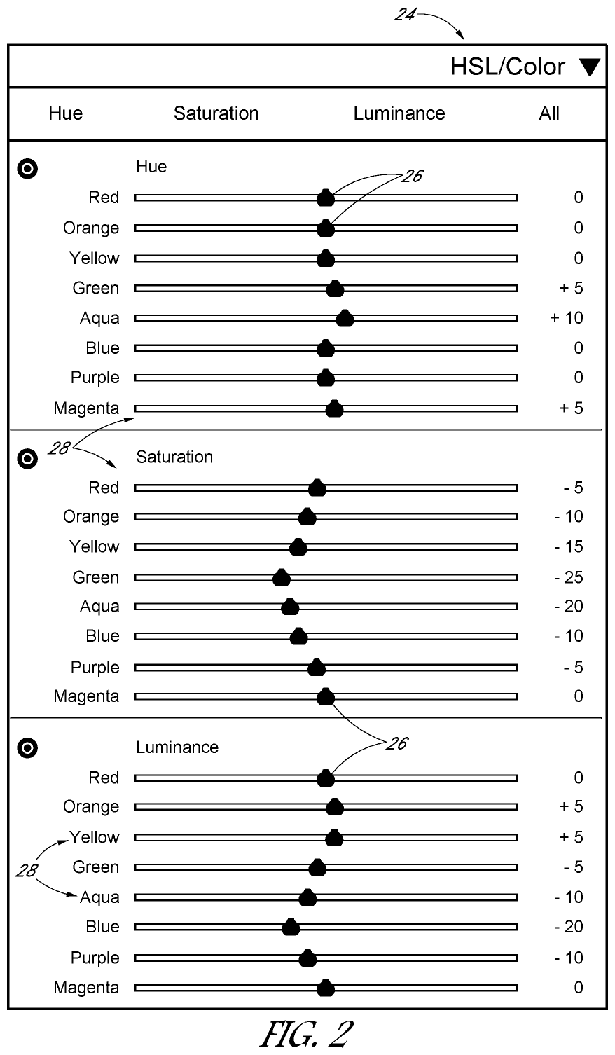

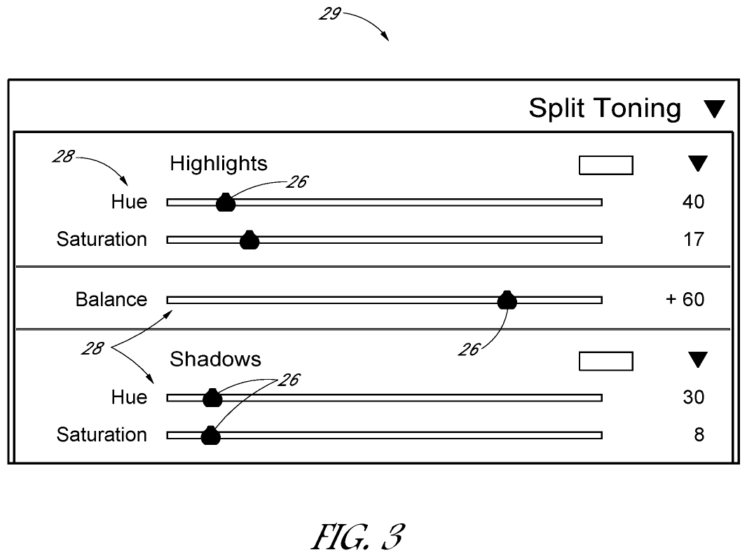

With additional reference to FIGS. 2 and 3, additional tools often provided by image editing software enable a user to manually adjust specific editing settings, each editing setting corresponding to a particular aspect of the image, so as to manipulate image coloring. FIG. 2 shows an HSL menu 24 that provides several sliders 26 that enable a user to adjust editing settings of several different aspects 28. The user can move each slider 26 over a range of settings to make a specific adjustment to the editing setting corresponding to that aspect 28. For example, in Adobe® Lightroom® editing software, sliders 26 in the HSL menu 24 enable users to adjust the hue (i.e., shade), saturation (i.e., color intensity) and luminance (i.e., brightness) of each of several different base colors (See FIG. 2). Further, an adjustment menu known as “split toning” 29 (see FIG. 3) provides sliders 26 enabling adjustment of hue and saturation in shadows (i.e., about the 25% darkest portions of the image) separately from hue and saturation in highlights (i.e., about the 25% brightest portions of the image). While other digital editing software packages may not use this particular organization, terminology and/or method of adjusting various editing settings, it is typical for image editing software to enable adjustment of a plurality of editing settings to manipulate the presentation of certain groups of pixels (i.e., to brighten pixels in shadows, brighten or darken pixels that include certain base colors such as red, green and blue, and the like). Further, while the illustrated embodiment employs sliders 26 to adjust editing settings, any of various graphic interfaces can enable such adjustments, including graphically-simulated knobs, direct numerical entry, location adjustment of points on a graph (such as the tone curve 22), or any other desired interface that enables adjustments of editing settings.

Manipulation of editing settings enables a user to emphasize, and even change, certain colors in the image so as to achieve the desired look. Some examples of typical “looks” include a black & white sepia look with which many are familiar. Another look may seek the effect of a vintage black & white photograph. Still further looks may emphasize certain visual effects, such as a “high contrast” look or “muted” look. Yet other looks may simply reflect a particular aesthetic achieved in a case in which a user experimented with editing settings and achieved a remarkable aesthetic effect for a particular image.

As noted above, some image editing software packages provide “presets” tied to particular looks. The presets include, in memory, a set of editing settings corresponding to a particular look. Thus, when the user has loaded a native mage and selects a particular preset, the software will apply the associated editing settings to the native image in order to modify aspects of the native image so as to achieve (or at least approximate) the associated desired look. Preferably, after the preset is selected and applied, the image will at least approximate the look, requiring only minor further adjustments to complete editing. Thus, application of a preset can help a user achieve a desired look quickly, without having to go through the laborious task of manually adjusting a multitude of editing settings for each image. Presets thus can lead to great time savings for users.

As users improve in expertise, they often develop their own looks that define aesthetics they find particularly desired for particular scenes and/or compositions. Such users can save the editing settings for each particular look, defining presets of their own. Further, third parties can develop packs of multiple presets, each preset corresponding to a particular look. Such third party presets usually can be downloaded from an online source and then loaded/added to the image editing software package.

Presets, however, have limitations because of the broad range of variables associated with photographic images. For example, a preset that results in a visually stunning and beautiful image of a mountain landscape may, if applied to a close-up portrait shot with a flash, result in an unnatural-looking and undesirable image. Additionally, images of the same mountain landscape shot at different times of the day—and thus subject to different underlying lighting conditions—will each look different from one another notwithstanding application of the same preset. Thus, the time-saving utility of presets is limited due to variations of conditions (such as lighting conditions, scene conditions, composition conditions, dynamic range, etc.) in the underlying original, or native, digital image.

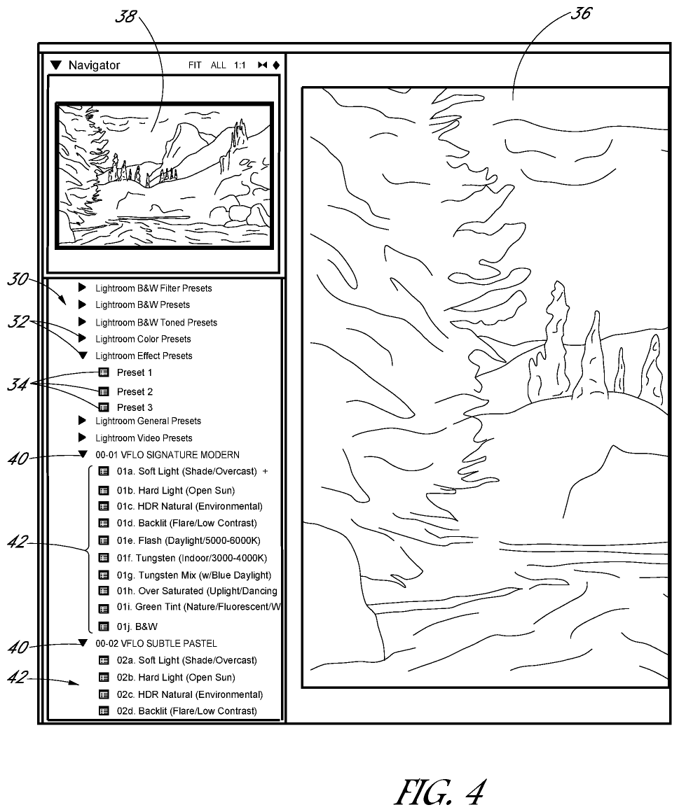

With reference next to FIG. 4, in one example, Lightroom®, a digital image editing software package available from Adobe®, provides a presets menu 30. In the illustrated embodiment, the menu 30 lists a plurality of families 32 of presets. Holding the cursor over the category, as depicted in FIG. 4, may open a drop-down menu of presets 34 in that particular family 32. Selecting one of these presets 34 will apply the associated editing settings to the native image being edited. In one embodiment, a first version 36 of an image, prior to application of the preset, is displayed concurrently with a second version 38 of the image, depicted with the preset applied.

Often professional photographers wish to produce a collection of images that share a similar look. For example, a wedding or event photographer may wish for all, or substantially all, of the images associated with the wedding or event to be consistent with a common theme—sharing a look. However, it is anticipated that such images will be shot over a broad range of time and locations, resulting in substantial differences in light and other conditions during image capture. Such conditions can range from morning to afternoon and evening natural light, to indoor and flash-assisted artificial light. Since images captured in different light conditions can be expected to respond differently to application of the same preset, the photographer may apply the preset to images shot under certain lighting conditions but will have to manually edit most of the photographs in order to achieve the desired look across the group of images. The time-saving value of existing presets is thus limited.

A significant factor in understanding why images respond differently to applications of presets is the discovery that images having different lighting scenarios respond differently to editing approaches during image development. Through experience and study we have determined that there are over 40 different lighting scenarios that photographers run into on a regular basis. Thus, there can correspondingly be over 40 different optimal image development approaches that photographers can take when editing images. As this appears to be more complex than most humans can keep straight, we further analyzed each lighting scenario and discovered commonalities in how certain scenarios are typically treated during editing. For example, it was determined that scenarios such as overcast, shade, diffused window light, diffused flash, or otherwise ideal light sources should all be treated similarly in the editing process. Based on these discoveries of commonalities, the lighting scenarios have been grouped into nine groups, which for purposes of this document will be referred to as lighting conditions. As noted, images having the lighting scenarios within each lighting condition group can be edited in a similar manner in order to achieve a desired result. The lighting conditions, and a brief overview of the lighting scenarios included therewithin, are listed and described below:
1. Soft Light—Shade, overcast, doorway, soft window light, dawn/dusk, diffused flash, or otherwise soft and ideal light sources. These images are characterized by good color and a moderate level of overall image contrast.
2. Hard Light—Open sun, hard direct flash, direct window light, direct sunlight and other small light sources. These images are characterized with more vivid colors and a high level of contrast with bright specular highlights and deep shadows.
3. HDR—High Dynamic Range images consists of any lighting scenario where the photographer is shooting from shadows into direct light. The highlights are extreme, shadows are extreme, with a below average level of midtones. These images are characterized by the “U” shaped curve within the image histogram.
4. Backlit—Backlit lighting conditions consist of light directly entering the lens. This can come from mid-day sun, later afternoon to golden hour sun, as well as direct light sources like flashes and constant lights. Backlit images are characterized by a washed look to the overall colors and low image contrast.
5. Tungsten—Indoor warm and orange lighting. Most commonly created by “soft white” style indoor light bulbs, candles, or otherwise warm light sources. Late evening sunsets can often take on a tungsten/orange hue as well.
6. Tungsten Mix—Indoor tungsten light with a mixture of blue daylight, usually coming through windows, doors, ceiling lights, or other. These images are generally shot indoors but earlier in the day when it's still bright outside. Tungsten Mix is characterized by deep orange from the indoor lights mixed with bright and usually blown out daylight blue tones.
7. Green Tint—Green tinted light sources consist of light reflecting off leaves/grass in nature, window tinting in hotels or office buildings, or fluorescent green tones that might be created by office tube lighting. These images are characterized with green tones or a “green tint” that is mixed into all of the other colors in the image.
8. Red Tint—Red tinted light sources consists of light reflecting off red brick walls and reddish surfaces, redrocks that might be found in places like Arizona, or even sunset oranges that are bouncing off of sand. It can even be found consistently in pink/reddish hued sunsets that can be seen in California/Arizona and other places around the world. These images have a similar red tinting to all color tones in the image.
9. Over Saturated—Hyper saturated light sources like concerts and dance floors where overall image saturation must be modified.

In accordance with a preferred embodiment, and in view of the development of the lighting condition groups, a coordinated preset group 40 can be provided comprising a plurality of condition presets 42 that are coordinated one with another, each condition preset 42 being tied to one of the lighting conditions and configured to set image editing settings to achieve a desired look when applied to a native image having the corresponding lighting condition. In this manner, during image development, a user can start with native images having a variety of lighting conditions, and, by applying corresponding ones of the condition presets 42, develop the native images to each approximate the same desired look.

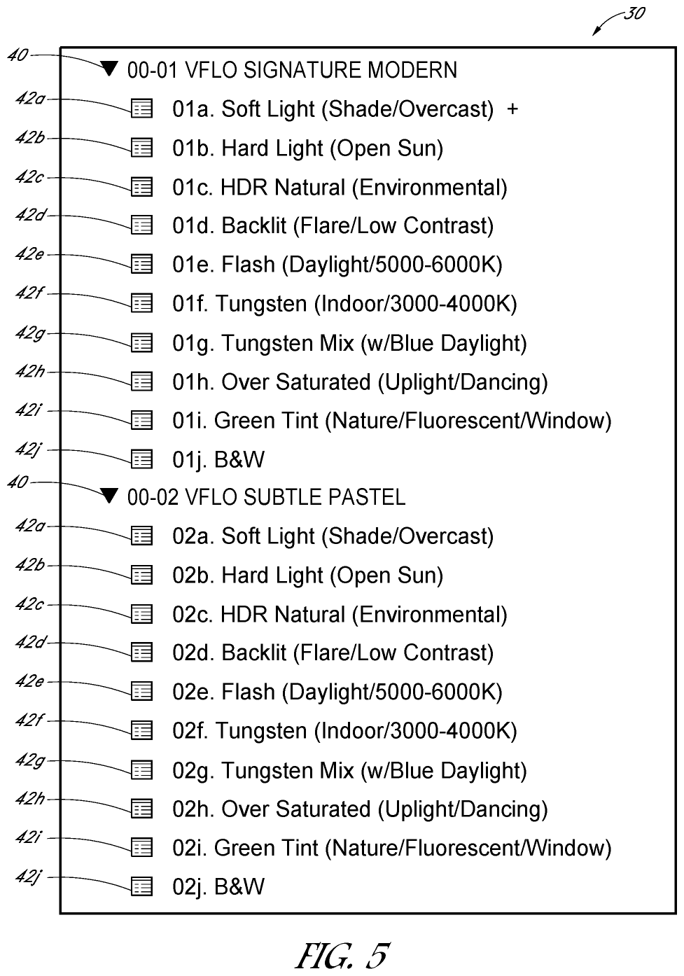

In one embodiment, a coordinated preset group 40 comprises 10 condition presets 42. For 9 of the condition presets 42, each preset is tailored to achieve the same desired look, but each starting with native images having a different one of the 9 underlying lighting conditions listed above. For example, with reference to FIG. 5, a first condition preset 42a of the coordinated preset group 40 is configured to achieve the desired look when applied to a native image captured in lighting condition 1: Soft Light. A second preset 42b of the coordinated preset group 40 is configured to achieve the desired look when applied to a native image captured in a different lighting condition 2: Hard Light. Consistent with this pattern, third through ninth presets 42c-42i of the coordinated preset group 40 are configured to achieve the desired look when applied to respective native images captured in lighting conditions 3 through 9. It is to be understood that such condition presets 42 need not be exact in achieving the look. Rather, each condition preset 42 of the coordinated preset group 40 is configured to transform the native image to which it is applied to approximate the desired look so that a user need apply only relatively minor further edits to fully achieve the desired look.

Preferably the coordinated preset group 40 can be downloaded or otherwise imported into an image editing software package. With continued reference next to FIGS. 4 and 5, in one preferred embodiment coordinated presets groups 40 can be displayed in a presets menu 30 of the image editing software. In the illustrated embodiment, along with other preset families 32, the menu 30 displays two coordinated preset groups 40: “00-01 VLFO SIGNATURE MODERN” and “00-02 VFLO SUBTLE PASTEL”. When the user selects a coordinated preset group 40, a submenu opens listing each of the condition presets 42 in the coordinated preset group 40, as also shown in FIG. 5. In this embodiment, the user determines which of the categories of lighting conditions the native image falls within, and selects the condition preset corresponding to the lighting condition category. The selected condition preset 42 will adjust the editing settings of the native image in a manner to transform the native image in the identified lighting condition category to approximate the desired look.

After the condition preset 42 has been applied, the edited image should approximate the desired look. It is anticipated that sometimes the user may desire to further modify the editing settings even after the preset has been applied in order to fine-tune the image. As every image is different, it is anticipated that such fine-tuning will be needed from time to time, but that such fine-tuning preferably will entail relatively modest adjustments to editing settings.

With continued reference to FIG. 5, in the illustrated embodiment, each of the coordinated preset groups 40 includes condition presets 42a-42i corresponding to each of the lighting conditions listed above, and additionally comprises a condition preset 42j titled “B&W” which is configured to transform a color image having the desired look to a black & white version of the desired look.

Notably, in the illustrated embodiment, there isn't a B&W condition preset 42j for each of the lighting conditions. Rather, the B&W condition preset 42j is configured to transform a color image that is already edited to have the desired look into a black & white version consistent with the desired look. Thus, if a user wishes to edit a native digital image into a black & white version having the desired look, the user will first identify the native image's lighting condition, then apply the condition preset 42a-42i corresponding to that lighting condition. The user preferably will then make fine-tuning adjustments to editing settings to fully achieve the desired look—in color. Once the desired look is achieved in color, the user may apply the B&W condition preset 42j, which will transform the image to approximate the black & white version of the desired look. The user may then make additional fine-tuning adjustments to editing settings as needed until the image achieves the desired B&W look.

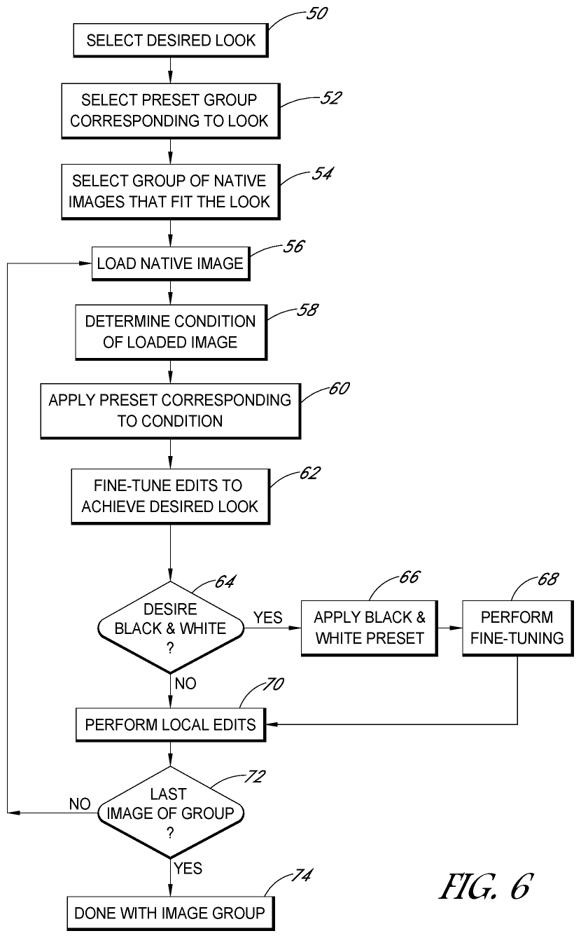

A coordinated preset group 40 having aspects as described herein can be used to speedily edit a large group of images having varying underlying light conditions to achieve a common desired look across the group of images. With reference next to FIG. 6, in order to edit such a large group of native images to have a common desired look, the user preferably first selects the desired look 50 and identifies 52 the coordinated preset group 40 corresponding to that desired look. Most preferably, the user also reviews and selects 54 each native image so that each image in the group can be expected to fit with the desired look. The user loads 56 a first one of the native images, and determines the condition 58 of the loaded image. The user then opens the appropriate presets menu corresponding to the selected coordinated preset group and selects the preset corresponding to the lighting condition of the loaded image. Application 60 of the preset will transform the native image to approximate the desired look. The user then preferably manually fine-tunes 62 the editing settings as needed to achieve the desired look. Global editing of the color image is then complete. If the user wishes a black & white version 64 of the desired look, the user may then apply 66 the B&W condition preset 42j of the coordinated preset group, and then further fine-tune 68 the image editing settings. Once global editing of the image is complete, the user may desire to perform local editing 70 (such as of specific features, including faces, water, sky, etc.) in order to enhance the individual image.

The above-described process can be repeated 72 for each native image in the selected group of native images, until each of the native images has been edited 74 to achieve the desired look.

In the embodiments discussed above, and in other embodiments discussed herein, the coordinated preset group comprises nine condition presets configured to achieve a desired look starting with a corresponding one of nine different lighting conditions. This approach has proven particularly practical in dealing with most types of images while still maintaining a small-enough group of condition presets to be intuitive and manually manageable for most users. It is to be understood, however, that in additional embodiments, the coordinated preset group can be configured to address more, less, or different lighting conditions, may be configured to address subconditions, and/or may be configured to address conditions that are totally different than the lighting conditions that have been specifically discussed. For example, rather than having a single conditional preset for backlit images, individual conditional presets can be developed for backlit images having further subconditions, such as specific backlit aspects like sunsets, artificial white light, artificial colored light, water reflections, sunset water reflections, and may also retain a generic backlit condition preset. Still further embodiments may include subconditions considering non-lighting conditions, such as scene and composition types.

In additional embodiments, conditions can be developed to first consider factors other than lighting conditions, such as the dynamic range or contrast of an image, and within that dynamic range consider lighting conditions or the like.

In additional embodiments a native image may first be classified by its contrast level. For example, it can be first determined whether an image falls within one of a group of four contrast levels, such as 1) Moderate contrast (such as soft light); 2) High contrast (such as hard light); 3) Extreme shadow and highlights (such as HDR); or 4) Faded low contrast (such as backlit). Notably, the four example contrast levels just identified resemble the first four “lighting conditions” that are discussed above. Once the contrast level is determined, the light color of the image can next be determined. For example, it can be determined which of the light colors corresponding to lighting conditions 5-9 best describes the native image. Additional light colors can also be defined in additional embodiments. As such, a condition of a native image can be a combination of classifications and sub-classifications—here contrast level classifications plus light color classifications. Along these lines, even more sub-classifications can be considered, as the native image can still further be classified by a type of scene, such as portrait, landscape, action sports, and the like. The combination of each of these classifications & sub-classifications can define a “condition” for which a condition-based preset can be developed, and a coordinated preset group can include condition presets for each condition identified by classifications and sub-classifications. As such, although several embodiments discussed herein employ the intentionally-simplified system of 9 conditions corresponding to 9 lighting conditions, it is to be understood that many factors—and organizational methods—can be considered to identify a few general conditions or many very-specific conditions, possibly increasing the anticipated accuracy of each condition-based preset of the coordinated group. Although such a system may be quite complex, such a complex system may be amenable to automated computerized analysis of images, as artificial intelligence-based systems can be taught to recognize the various classifications and sub-classifications that could be combined to identify a particular native image as best fitting one of a plurality of defined conditions.

An inventive process can be employed to create a coordinated preset group corresponding to a desired look.

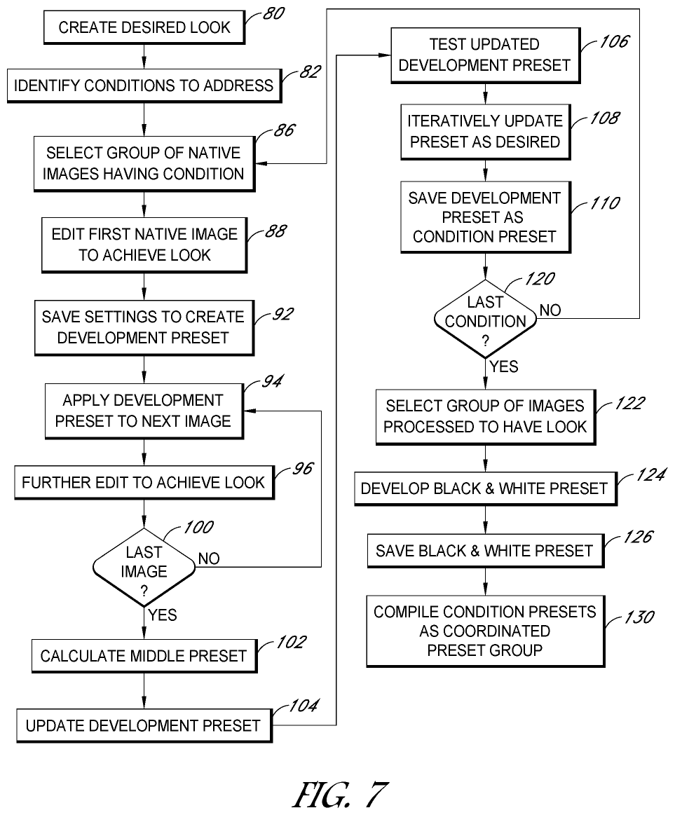

With reference next to FIG. 7, a first step of creating a coordinated preset group is to create 80 a desired look that the user wishes to achieve. In at least some situations, a specific look may fit well with some scenes or compositions, but not others. For example, a look that fits well with wide landscape scenes may not work well with close-up portraiture. Along these lines, along with identifying the desired look, a developer may also wish to define conditions to address 82 with the coordinated preset group. For example, and as discussed above, the developer may wish to define conditions depending on only certain light conditions or scenes that are amenable to the look, or may wish to develop a more thorough and complex set of conditions that considers dynamic range or contrast level of the underlying image along with a subset of lighting conditions and even, if desired, considering properties of composition, scene, and exposure of the image.

A plurality of sample native images are then selected 86. In a preferred embodiment, each of the selected sample native images includes scenes and composition that fit the desired look. In a preferred embodiment, the first group of selected sample native images are digitally captured in an ideal lighting condition, such as soft lighting. Usually it will also be desired that each native image be a high-quality shot, as it will used to create an ideal. Also, preferably the selected sample native images are taken in the raw format. However, it is to be understood that native images can be provided in other formats, such as TIFF and JPEG.

A development preset can be created, as discussed below. In a preferred embodiment that creates a development preset for Lightroom® image editing software, the development preset involves modifying editing settings including the Basic Panel, Tone Curve, HSL (Hue, Saturation, Luminance) and Split Toning adjustment menus.

In a preferred embodiment, one of the sample native images is modified 88 to achieve the desired look. Such modification can begin with modifications to the tone curve 22 (see FIG. 1), such as with the goals of boosting midtones, controlling highlights, and deepening contrast in the shadows. Preferably the tone curve 22 will be modified to include 5 to 7 points (A-E), and most preferably will be smooth and gradual in its transitions.

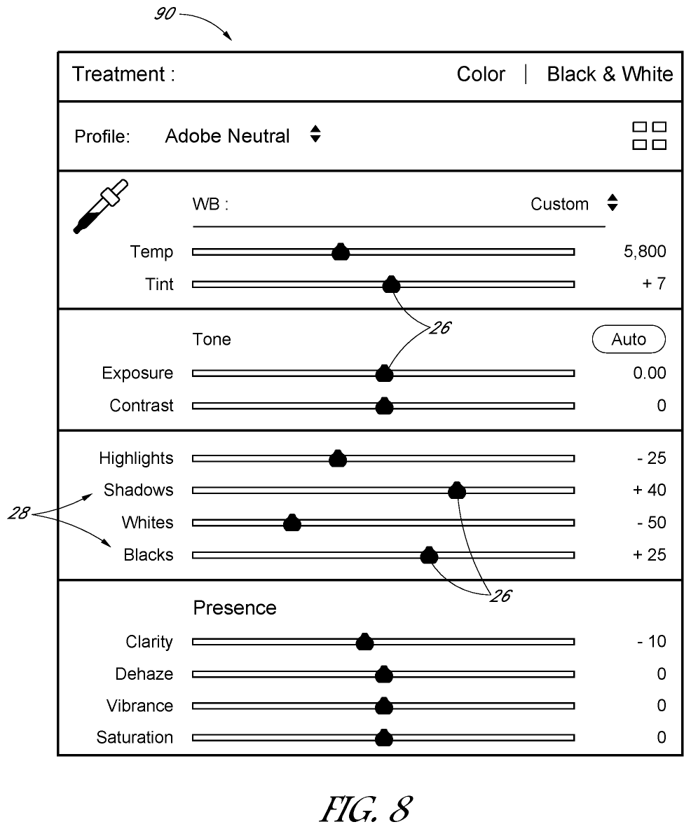

With additional reference to FIG. 8, the user preferably opens a Basic Panel menu 90 to adjust aspects 28 such as highlights, shadows, whites and blacks for the proper tonal response based on the desired look. Preferably adjustments to clarity are kept minor, and adjustments to dehaze, vibrance and saturation are avoided, as they have global color effects that are difficult to maintain consistently. Exposure and contrast preferably are not adjusted at the Basic Panel 90, and instead are included within the Tone Curve 22. Of course, in this embodiment terminology and organization of editing settings is taken from Lightroom®, and it is anticipated that other image editing software will include some editing settings that are adjusted while creating a profile, and other editing settings that are not adjusted while creating a profile, or that are adjusted at different times with particular tools.

With reference again to FIG. 2, hue, saturation and vibrance of individual colors preferably are adjusted independently in an HSL/Color adjustment menu 24. This better enables a user to develop a refined and consistent look than to adjust vibrance/saturation in the Basic Panel 90. A preferred goal for these adjustments is to achieve the look while retaining better colors, specifically across skin tones.

With reference again to FIG. 3, after HSL 24 adjustments, the user may add Split Toning 29 adjustments, which preferably are subtle, in order to smooth out the color tones within highlights and shadows.

The user may wish to again visit the Tone Curve 22 and Basic Panel 90 menus to make fine-tuning adjustments.

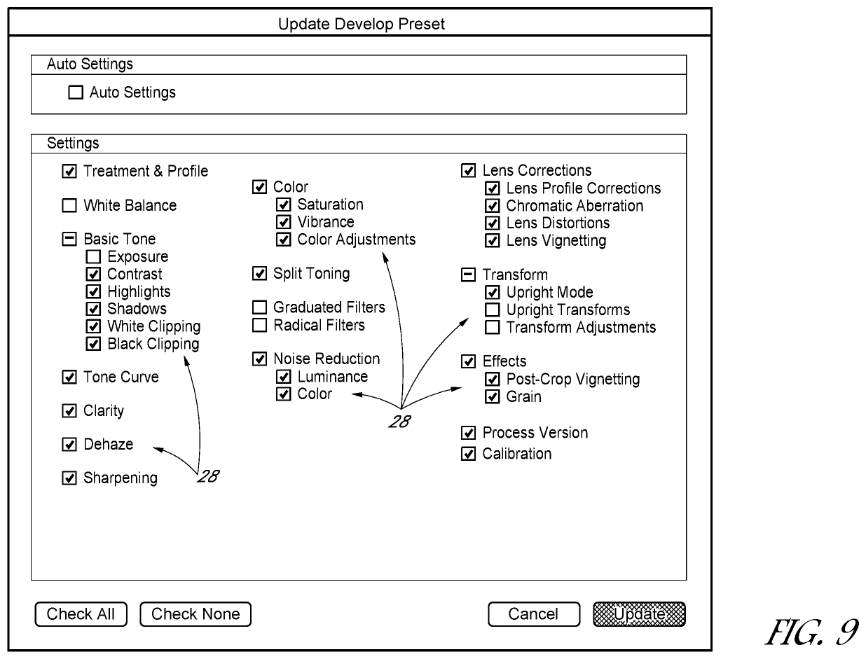

With continued reference to FIG. 7 and additional reference to FIG. 9, preferably the editing settings are saved 92 as a development preset. FIG. 9 shows that editing settings for some aspects 28 are anticipated to be saved as the development preset, but editing settings for some aspects 28 are not saved.

After the development preset is saved, it preferably is tested and refined. This can be accomplished by applying 94 the editing settings in the development preset to each of the selected sample native images in turn. For each of these images, preferably the user applies 94 the development preset to the native image (which changes editing settings to those saved in the development preset) and then performs further edits 96 to achieve the desired look. In a preferred embodiment, such further edits are first to dial in the appropriate white balance and exposure, and then make fine tuning adjustments to make each image achieve the desired look. Such fine tuning adjustments preferably include: 1) Basic Panel 90—highlights, shadows, whites, blacks & clarity; 2) Tone Curve 22 tweaks for exposure/contrast; and 3) HSL 24 and Split Toning 29. Once the image is satisfactorily edited, the editing settings for the modified image are then documented and/or saved 98.

Once all of the selected group of sample native images is satisfactorily edited 100, the values for each of the relevant editing settings (in one embodiment limited to the editing settings for the aspects in the Basic Panel, HSL and Split Toning menus, but other embodiments may include different, less, and more editing settings) are statistically analyzed in order to calculate a middle preset 102. In a preferred embodiment the middle preset 102 is calculated by taking the average of each of the documented editing settings across the group of selected sample images. Preferably, the group of selected sample native images is large enough so that each average editing setting comprises a statistically significant data sample. In a preferred embodiment, the group comprises thirty or more native images. In additional embodiments creation of a coordinated preset group 40 can be a grander endeavor including use of a larger human staff and even computing resources incorporating aspects of artificial intelligence, and thus such a group of sample native images can include thousands and even millions of images. It is to be understood that other statistical tools may also be employed. For example, in another embodiment the median of each monitored editing setting can be used rather than the average in calculating the middle preset.

The development preset preferably is updated 104 using the middle preset. In a preferred embodiment, the original development preset is replaced by the middle preset.

Preferably, the updated development preset is again tested 106 on the same and/or additional sample native images to ensure consistency. As desired, the development preset can be further iteratively improved and updated 108. In fact, it is to be understood that even after a coordinated preset group 40 is developed, ongoing iterative testing and updating 108 can take place to improve condition presets 42 within the coordinated group 40.

Once the developer is satisfied that the development preset satisfactorily approximates the desired look when applied to images having the corresponding condition, the development preset is saved as a condition preset according to the particular image editing software. When saved, the coordinated preset 42 preferably is tied to its corresponding group 40.

In the current embodiment, in which the development preset was developed using a soft lighting condition, the associated condition preset can be named to indicate that it is directed to soft light (see FIG. 5). As such, it is to be anticipated that when the Soft Light Preset is applied to a native image having a soft lighting condition, the image will be transformed to approximate the desired look.

In some embodiments a developer will select only a limited range of aspects 28 for which to save the editing settings in the preset. Preferably, check boxes enable the developer to select which aspects 28 are having their editing settings saved as part of the preset. For example, the developer can choose to save editing adjustments to the Basic Panel 90, Point (tone) curve 22, HSL 24 and Split Toning 29. It is to be understood that, in additional embodiments, similar or different aspects may be selected to be saved. In some embodiments, certain editing setting aspects 28, such as white balance/exposure can be excluded from being saved as part of the condition preset, perhaps because they are better adjusted on an individual image basis, and perhaps because the nature of the look is not conducive to such adjustments. Further, local adjustments, such as graduated/radial filters, preferably are not included when creating a preset, as such presets preferably are directed to making global edits that are applicable to a variety of specific photograph compositions. As such, it can be expected that a preset may be limited to addressing only specific editing settings.

With continued reference to FIG. 9, during development of a preset development profile in some embodiments a developer may choose to save some editing settings (such as, for example, lens corrections, transform, noise reduction and sharpening in some embodiments) that will not be saved in the ultimate preset. Such editing settings may be saved during development—usually for comparison purposes with other comparable presets—even though they will not be saved as part of the eventual preset. Of course, in additional embodiments, during development only the editing settings that are going to be saved in the preset are saved.

With reference again to FIG. 7, in the illustrated embodiment, the soft light preset was the first condition preset 42 of the group 40 to be developed. It can be preferred to develop the soft light condition preset due to the advantageous manner in which soft light typically lends itself to image editing. Of course, it is to be understood that, in some embodiments, and for some particular looks, it may be advantageous to start with native images having another condition.

Once the Soft Light Preset has been developed, the developer preferably moves on to developing 120 presets for each of the rest of the lighting conditions, generally repeating the process described above. For example, in some embodiments. for each condition preset, the user/developer selects a group 86 of sample native images (preferably a statistically significant number of images, such as 30+) having the associated condition, and edits each of them 88, 96 to achieve the desired look.

In some embodiments the process of creating other condition presets can take advantage of what was learned in the first preset. Specifically, the soft light condition preset can be applied to each image to provide a starting point for further processing, and the developer then processes 96 each image by first dialing in the appropriate white balance and exposure, and then making fine tuning adjustments to achieve the desired look, preferably comprising: 1) Basic Panel 90—highlights, shadows, whites, black, clarity; and 2) HSL 22 and Split Toning 29.

The editing settings for the Basic Panel 90, HSL 22 and Split Toning 29 edits are documented/saved 98 for each image, and a statistical calculation 102 (such as an averaging of each editing setting) is made to create a middle profile that is saved 104 as a preliminary condition development preset, which is saved.

Preferably the preliminary condition development preset is then tested 106 in two stages. In a first testing stage, preferably a statistically-significant sample of images (for example, at least 30-50 images) having the corresponding lighting condition are selected, and the development preset is applied to each of the native images. Fine-tuning editing is performed for each of the images, which may include at least some of the images used during initial development of the development preset. Editing settings are again documented/saved for each image, and a statistical calculation is again performed to create a middle preset, which is used to update 104 the development preset. It is anticipated that, after this first stage, the updated condition development preset will be in close-to-final condition.

In a second testing stage employed in connection with another embodiment, the updated condition development preset is further iteratively tested 108 and updated over a much-expanded group of native images (for example, 250 or more native images) having the corresponding condition. The second testing stage is anticipated to provide some fine-tuning to the development preset. Preferably, the updated condition development preset is considered to be working appropriately when, after a native image is adjusted to the appropriate exposure and white balance, additional adjustments necessary to achieve the desired look are minimal. When working appropriately, the collection of editing settings is saved as a finalized version of the condition development preset. Preferably, when finalized, a user applying the condition development preset will be able to achieve the desired look quickly, with only minimal editing adjustments. When finalized, the condition development preset can be saved 110 as a condition preset 42, and added to the group 40.

In some embodiments, adjustments to the Tone Curve 22 are avoided when developing the condition development preset after development of the original development preset. That is, the tone curve 22 developed and saved when developing the first condition preset is substantially maintained for all of the condition presets. This approach enables simplification of statistical calculations. In other embodiments, however, development of condition development preset can also include adjustments to the Tone Curve.

Once all of the individual condition presets are developed, a black & white preset can be developed. The black & white preset 42j preferably is configured to shift a color image that already has achieved the desired look to a black & white version. Thus, to develop the black & white preset for the coordinated preset group, a user starts 122 with a group of images already edited to achieve the desired look. A B&W preset 42j is then developed 124, preferably using a process similar to that discussed above, with the exception that only editing setting aspects in a B&W Mix menu are employed to transform the color image to black & white. The statistical middle preset of such editing settings are saved 126 as the B&W preset.

Once a condition preset for each condition has been developed, the condition 42 presets can be compiled 130 and saved as a coordinated preset group 40. Such a coordinated preset group can be configured to be loadable into an existing image editing software package, or can be included with an image editing software package.

Notably, in a preferred embodiment, the B&W condition preset 42j of a coordinated preset group 40 can be used somewhat differently than others of the condition presets. Specifically, a native color image is first edited to achieve the desired look, such as by using the appropriate one of the condition presets. The B&W condition preset 42j can then be applied to further transform the transformed image to a black & white image still having the desired look, preferably with only minimal fine-tuning.

In embodiments specifically discussed above, when using a coordinated preset group to achieve a desired look, a user determines the lighting condition of the image so as to select the appropriate preset. In other embodiments, artificial intelligence (AI) software may be employed to evaluate native images and classify them into the correct one of the conditions addressed in the coordinated preset group. For example, in one embodiment, the user can select a coordinated preset group 52 corresponding to the desired look, and the AI software will analyze the native image, determine the condition 58 of the image, select the appropriate condition preset, and apply 60 the selected condition preset to the native image. Use of AI to determine the appropriate condition can be especially useful in situations in which many conditions are defined having a broad range of complexity. For example, while some embodiments can employ nine discrete conditions limited to lighting and apparent to most human editors, AI can be trained to identify and classify several factors concerning images, and thus may be able to consider many of such factors in determining the condition of a particular image. As such, complex definitions of conditions (such as employing several classifications and sub-classifications) may be employed, enabling development of condition presets that are narrowly-tailored to specific conditions. In some embodiments, AI programmed to identify the condition of an image may be run separately from other aspects of image editing, being limited to identifying the appropriate condition for the user so that the user can select the corresponding condition preset of the coordinated preset group.

In additional embodiments, AI can be employed to further facilitate processing of native images. AI currently exists for analyzing digital images and identifying and/or determining certain aspects, features and even objects. In a preferred embodiment, an AI system can be programmed with knowledge of a plurality of looks and coordinated preset groups associated with such looks, including an understanding of conditions that lend themselves to particular looks. With reference next to FIG. 11, in another embodiment a user can upload a native image 140 for editing, and the AI system can analyze 142 the native image to determine several factors, such as the image's dynamic range, lighting conditions, scene, composition or the like. The AI can also identify localized features/objects 144, such as faces, water, sky and clouds. Based upon the AI analysis and the programmed knowledge, the software can suggest 146 a range of looks and options that will work best. The user can then make a selection 148 in view of the suggested looks and options. Of course, in some embodiments the user can select a look prior to or independent of any AI analysis or in spite of suggestions by the AI.

A user can provide input 148, such as selecting a desired look and also providing instructions for how to deal with localized features that may have been identified by the AI. A user's desired overall look for the image may not work well for certain localized features. Thus, a user input 148 may include whether such localized features should be treated differently than the image globally. For example, some looks may involve a high level of contrast, but some features, such as faces, typically don't present well with high contrast. As such, the user input may instruct a different type of look be applied to faces than is applied globally to the image. Along such lines, the user can decide that a plurality of different localized features be treated differently than the native image is treated globally, and a user-selected look, AI-suggested look, or no edits at all, may be applied to the localized feature. The user can also determine that a particular localized feature receive no special treatment, but be subject to the global application of the selected condition preset.

Once a user has provided input 148, the AI can select 150 one or more coordinated preset groups 40 to provide a global look to the image while applying a different look to certain of the localized features. The AI, based on analysis of the native image, can determine 152 the relevant condition, and select the corresponding condition preset 42 of the coordinated preset group 40. The selected condition preset 42 is then applied 154 to the native image. If the user has directed 156 that one or more localized features be treated differently, the AI can apply 158 a different, localized condition preset to the localized feature(s). At this point, the process can end 160, and the image should approximate the desired look, requiring little, if any, further editing by the user.

As noted above, certain coordinated preset groups 40 affect a limited set of editing settings corresponding to certain aspects, leaving other editing settings corresponding to other aspects to the user. In some embodiments, some coordinated preset groups 40 can be directed to a limited group of editing settings that are not covered by other groups 40. For example, one embodiment of a coordinated preset group is directed to correcting problems in the quality of shooting the photograph, such as exposure problems and/or noise. Such problems may be independent of the conditions addressed in the coordinated preset group. In some embodiments, an AI system can be programed to have criteria to analyze a digital image and identify such problems, and then to select a condition preset to address and resolve such problems in addition to a condition preset directed to achieving a desired look. For a well-shot image that does not have such problems, however, the AI system can be programmed to detect that such problems do not exist, or at least do not exceed a threshold evaluation criteria for identifying such problems, and will only apply the condition preset directed to achieving the desired look.

In embodiments discussed above some of the steps and considerations are made in a particular order. While the order may be important in some embodiments, it is anticipated that variations in the particular order of steps, combinations of steps, addition or deletion of discussed steps, or the like may be appropriate in other embodiments, and may be consistent with the inventive principles discussed herein.

In additional embodiments it is anticipated that a particular condition preset that generally achieves the desired look for certain conditions can be further optimized for one or more secondary conditions that may be present in the native image. In some embodiment such a secondary condition could merit development of an independent condition preset. In another embodiment, however, rather than having an entirely different condition preset, the primary condition preset can include one or more secondary profiles (or secondary presets), which are saved presets that include editing settings similar to the primary condition preset upon which the secondary preset is based, but having some modified editing settings adapted to optimize the desired look in consideration of the secondary condition. In use, if a user, or an AI system, determines that a native image matches a first condition, but also includes a secondary condition, the selected primary condition preset and the appropriate secondary preset associated with the primary condition preset will be applied. For example, in one embodiment a primary condition preset can be developed for achieving a desired look in a soft light condition. During development, or perhaps in later development, it can be determined that if an image having the soft light conditions (the first, base, or primary condition) also includes a water feature (a secondary condition), then the look is best achieved with a few minor adjustments to some of the editing settings of the primary condition preset. Thus, a water feature secondary preset can be developed as a secondary preset to the first condition preset, which water feature secondary preset will only be applied if both the primary condition and secondary condition are satisfied by the native image. It is anticipated that multiple secondary condition presets can be developed for each primary condition preset, so as to optimize the primary condition preset for secondary conditions based on factors such as scene, localized features, composition, dynamic range, etc.

Inventive principles discussed herein can also be applied in many ways. For example, the embodiments just discussed anticipate modifying a condition preset based on a secondary consideration. This principle can be employed in other ways. For example, during development of a condition preset a developer can identify secondary conditions in native images having a primary condition that are being used to develop a condition preset for the primary condition. During statistical analysis of the saved editing settings to develop a middle profile, it can be noted that images with some secondary conditions are optimized with editing settings that vary from the average or median of the group as a whole. As such, in an additional embodiment, the statistical middle profile can be calculated to be a range of values for one or more of the editing settings, and can include optimal values (such as an average or median or a portion of a standard deviation from the average or median) for each of the group of images having the primary condition taken as a whole, the group of images having the primary condition but none of the tracked secondary conditions, and individual groups of images having both the primary condition and one or more of each tracked secondary condition.

In this embodiment, a determination can be made (provided by the user, one or more of various sensors, and/or an AI system) as to whether the native image includes one or more of a plurality of secondary conditions. The optimal value(s) of the condition preset best matching the determination is then applied to the native image in order to achieve the desired look.

The embodiments discussed above have disclosed methods and structure with substantial specificity. This has provided a good context for disclosing and discussing inventive subject matter. However, it is to be understood that other embodiments may employ different specific structural shapes and interactions. Also, specifics and terminology have been discussed in the context of the Adobe® Lightroom® image editing software. However, as discussed above, there are several image editing software packages available, and the inventive aspects discussed herein are applicable in connection with other software packages that may use different technology and enable editing tools that are configured or applied somewhat differently and to differently-configured aspects.

Additionally, embodiments discussed above have been discussed in the context of post-processing, in which a digital image is edited after it is captured. It is to be understood that, in additional embodiments, principles discussed herein can be applied before an image is actually captured and saved as a digital image file. For example, a camera device, such as a wireless phone, tablet or the like, can present on its display a view through the device's camera, and can present options for applying looks to the image currently being displayed, but not yet captured. Upon receiving input from a user (or an AI system), a condition preset can be applied to the image displayed on the device screen to show how the image would appear if a particular look is desired. The user can actually capture and save the image while the display is showing the image with the condition preset applied. The image can be saved in any of various ways. For example, the image may be saved in a raw, unedited format despite the edited version displayed on the screen, can be saved with the condition preset settings, can involve saving of multiple images—one raw and another including the applied condition preset, or in any other manner.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. A method for editing a group of native images using an image processing software, comprising:
selecting a coordinated preset group corresponding to a desired look to be shared by the group of native images after editing, the coordinated preset group comprising a first preset and a second preset, the first preset comprising a first group of image editing settings that, when applied to a native image having a first condition, modify the native image to approximate the desired look, the second preset comprising a second group of image editing setting that, when applied to a native image having a second condition, modify the native image to approximate the desired look;
determining that a first native image of the group of native images has the first condition;
applying the first preset to the first native image to transform the first native image to a first transformed image;
determining that a second native image of the group of native images has the second condition; and
applying the second preset to the second native image to transform the second native image to a second transformed image.

2. The method of claim 1, wherein the first and second transformed images both approximate the desired look.

3. The method of claim 1, additionally comprising determining whether a third image of the group of images has the first condition or the second condition, and applying the first preset to the third image if the third image has the first condition, and applying the second preset to the third image if the third image has the second condition.

4. The method of claim 1, wherein the first condition is a first lighting condition and the second condition is a second lighting condition.

5. The method of claim 1, additionally comprising applying a third preset to the first transformed image.

6. The method of claim 5, wherein the third preset is configured to transform the first transformed image from color to black and white while maintaining the desired look.

7. The method of claim 1, wherein the image editing software enables adjustment of a first plurality of editing settings, and wherein the first and second presets adjust a second plurality of editing settings that is a subset of the first plurality of editing settings.

8. The method of claim 1, wherein applying the first preset to the first native image comprise adjusting editing settings associated with the first native image to match the first group of editing settings.

9. The method of claim 8, additionally comprising defining a first localized feature of the first image, and wherein applying the first preset to the first images comprises excluding adjustments of editing settings within the first localized feature.

10. The method of claim 1, comprising an artificial intelligence analyzing the first native image and determining that the first native image has the first condition.

11. The method of claim 1, wherein the first condition comprises a first plurality of lighting scenarios, and wherein images exhibiting any of the first plurality of lighting scenarios will achieve a similar aesthetic result when edited in a similar manner.

12. A method of creating a coordinated image editing preset group for use with image editing software, comprising:
determining a desired look;
identifying first through nth first native images having a first condition;
for each of the first through nth first native images:
modifying editing settings to create a respective first transformed image having the desired look and having a plurality of respective first editing settings; and
documenting the plurality of respective first editing settings of the respective first transformed image;
calculating a first middle profile comprising a statistical calculation considering the plurality of respective first editing settings of each of the first through nth first transformed images, the first middle profile comprising a plurality of first middle editing settings;
saving the plurality of first middle editing settings as a first condition preset of the coordinated preset group;
identifying first through nth second native images having a second condition;
for each of the first through nth second native images:
modifying editing settings of the respective second native image to create a respective second transformed image having the desired look and having a plurality of respective second editing settings; and
documenting the plurality of respective second editing settings of the respective second transformed image;
calculating a second middle profile comprising a statistical calculation considering the plurality of respective second editing settings of each of the first through nth second transformed images, the second middle profile comprising a plurality of second middle editing settings; and
saving the plurality of second middle editing settings as a second condition preset of the coordinated preset group.

13. The method of claim 4, wherein the first condition is a first lighting condition and the second condition is a second lighting condition.

14. The method of claim 4, additionally comprising modifying editing settings of a plurality of color images having the desired look to transform each of the plurality of color images into a black & white image having the desired look, saving the modified editing settings of each black & white image, calculating a black & white middle profile comprising a statistical calculation considering the modified editing settings, the black & white middle profile comprising a plurality of black & white middle editing settings, and saving the plurality of black & white middle editing settings as a black & white preset of the coordinated preset group.

15. The method of claim 4, wherein the statistical calculation comprises calculating an average or identifying a median.

16. The method of claim 4, additionally comprising:
identifying a creation native image having the first condition;
modifying editing settings for the creation native image to transform it to a creation transformed image having the desired look;
saving a plurality of the initial editing settings of the creation transformed image as a development profile; and
for each of the first through nth first native images, applying the saved initial editing settings to the respective first native image.

17. A coordinated preset group configured for use with an image editing software, comprising:
a first condition preset comprising a first group of editing settings, and configured so that when the first condition preset is selected by the image editing software, the first group of editing settings replace a corresponding existing group of editing settings of a native digital image; and
a second condition preset comprising a second group of editing settings, and configured so that when the second condition preset is selected by the image editing software, the second group of editing settings replace a corresponding existing group of editing settings of the native digital image;
wherein the first group of editing settings is configured so that when it replaces a corresponding existing group of editing settings of a first native image having a first condition, the first native digital image is transformed to a first transformed image having a desired look;
wherein the second group of editing settings is configured so that when it replaces a corresponding existing group of editing settings of a second native digital image having a second condition. the second native digital image is transformed to a second transformed image having the desired look; and
wherein the first condition differs from the second condition.

18. The coordinated preset group of claim 17, wherein the first and second conditions consider one or more of a contrast level, lighting condition, scene, and composition of the native image.

19. The coordinated preset group of claim 17, wherein the first and second conditions are different from one another and comprise one of a soft light condition, a hard light condition, a high dynamic range condition, a backlit condition, a tungsten condition, a tungsten mix condition, a green tint condition, a red tint condition, and an over saturated condition.

20. The coordinated preset group of claim 19, wherein the first condition comprises a first plurality of lighting scenarios, wherein images exhibiting each of the first plurality of lighting scenarios achieve similar aesthetic results when edited in a similar manner, wherein the second condition comprises a second plurality of lighting scenarios, and wherein images exhibiting each of the second plurality of lighting scenarios achieve similar aesthetic results when edited in a similar manner.
